(19) United States
(12) Patent Application Publication
(10) Pub. No.: US 2025/0371759 A1
(43) Pub. Date: Dec. 4, 2025

(54) Visually Similar Variable Font Custom Instance Extraction using Differentiable Rasterizer

(71) Applicant: Adobe Inc., San Jose, CA (US)

(72) Inventors: Nipun Jindal, Delhi (IN); Zhaowen Wang, San Jose, CA (US); Oliver Brdiczka, San Jose, CA (US)

(73) Assignee: Adobe Inc., San Jose, CA (US)

(21) Appl. No.: 18/680,687

(22) Filed: May 31, 2024

(51) Int. Cl. G06T 11/20; G06F 40/109

(52) U.S. Cl. CPC G06T 11/203; G06F 40/109

(57) ABSTRACT

Variable font visual similarity search techniques are described. In an implementation, a query is received referencing an input font for performing a visual similarity search. A search result is generated specifying at least one variable font that is visually similar to the input font by searching a plurality of variable fonts based on the query. The search includes forming a plurality of instances for the at least one variable font, respectively, by adjusting a plurality of axes usable to change an appearance of the at least one variable font and identifying the at least one variable font by comparing the plurality of instances with the input font using a machine-learning model. The search result is presented for display in a user interface.

### BACKGROUND

Fonts are usable to change the ways, in which, characters such as letters, numbers, punctuation marks, and so forth are expressed as part of digital content creation. To do so, hundreds of millions of different fonts are available for use in a variety of creative contexts. Conventionally, each of the fonts are made available via a plurality of respective font files to change the appearance of related instances for a single font, such as to support bolded and italicized instances of an “arial” font through separate font files.

As a way to expand the expressiveness of fonts, additional types of fonts have been developed that are referred to as “variable fonts.” In a variable font, axes are definable (e.g., via a user input) to change an appearance of the font using a single font file. User inputs, for instance, may be received to change values of axes for a single font defined within a single font file to alter a visual appearance of the variable font in a desired manner, e.g., to “bold” the font. This variability and customization support, however, has introduced numerous technical challenges that cause functionalities that support user interaction with fonts to fail, result in inaccuracies, and inefficient utilization of computational resources.

### SUMMARY

Variable font visual similarity search techniques are described. In one or more examples, a font search system performs a visual similarity search based on a query, e.g., a query input font, a query digital image depicting a query input font, and so forth. The font search system then locates one or more variable fonts from a variable font library having instances (e.g., as defined by the respective axes) that are visually similar to the query. A search result is then output, which is configurable to include values for axes of the variable font that result in visual similarity of the variable font with the input font.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

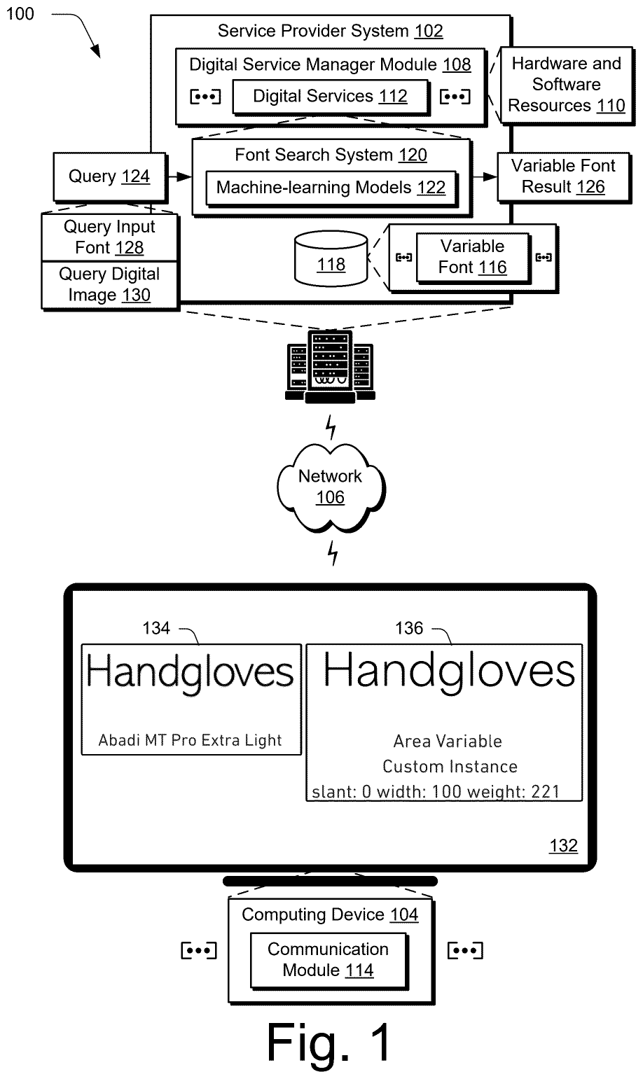

FIG. 1 is an illustration of a digital medium environment in an example implementation that is operable to employ variable font visual similarity search techniques described herein.

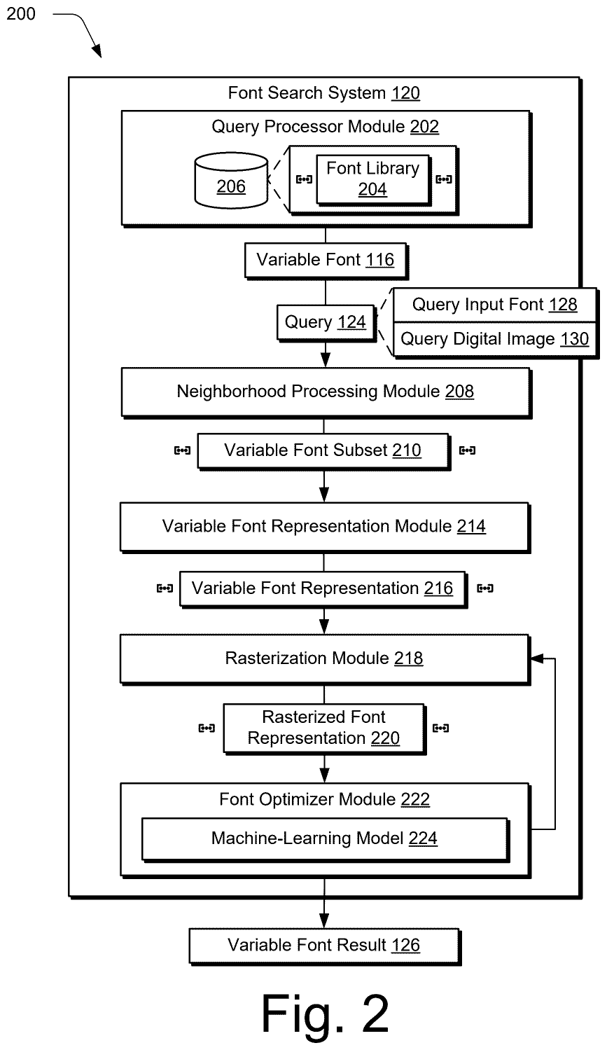

FIG. 2 depicts a system showing operation of a font search system of FIG. 1 in greater detail.

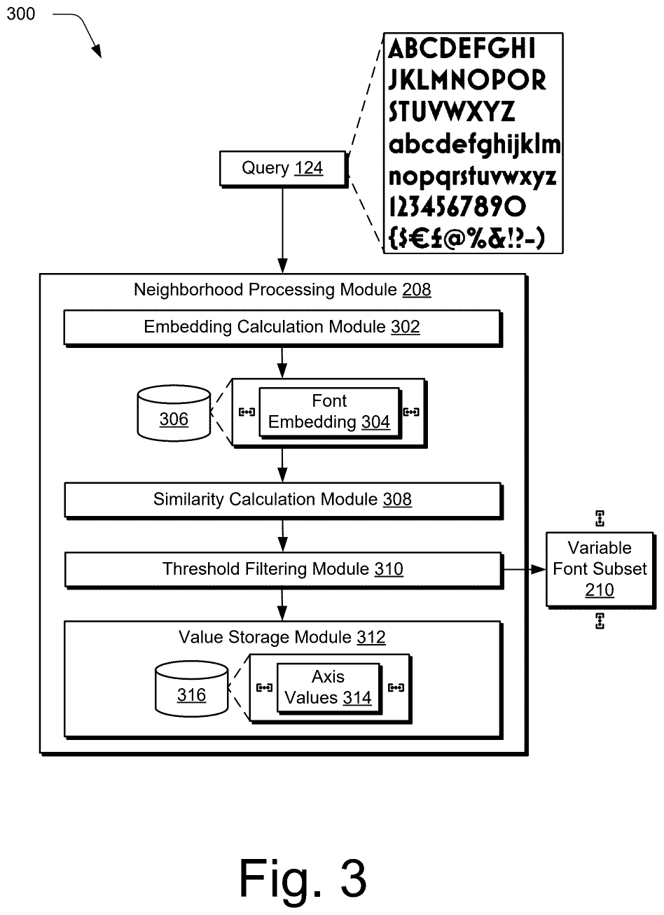

FIG. 3 depicts a system showing operation of a neighborhood processing module of FIG. 2 in greater detail.

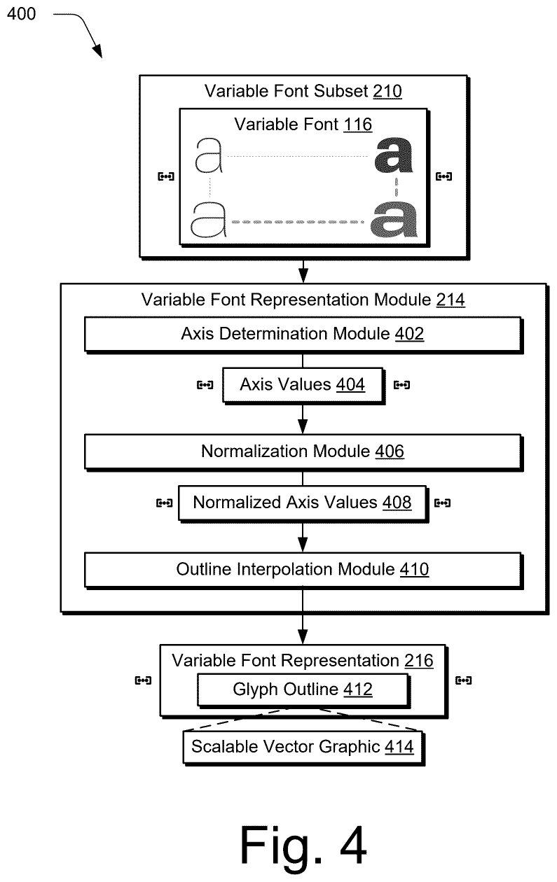

FIG. 4 depicts a system in an example implementation showing operation of a variable font representation module of FIG. 2 in greater detail.

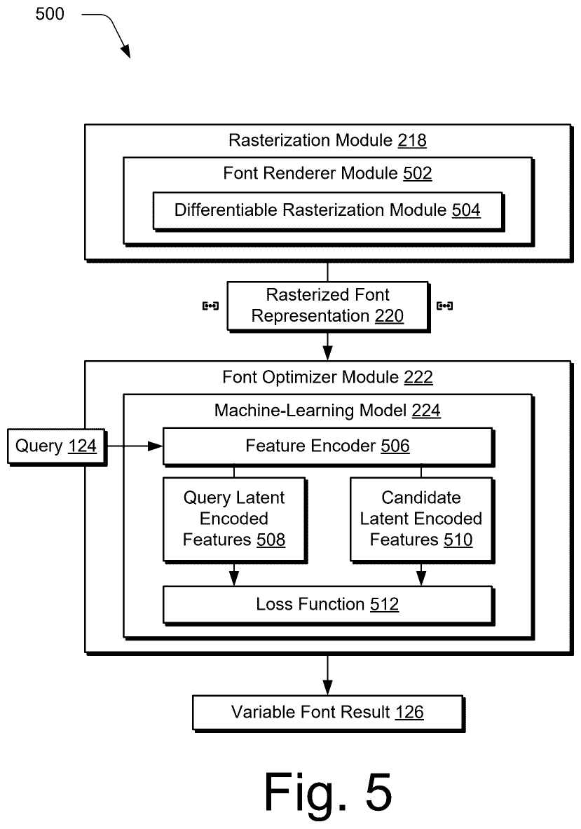

FIG. 5 depicts a system showing operation of a rasterization module and font optimizer module of FIG. 2 in greater detail.

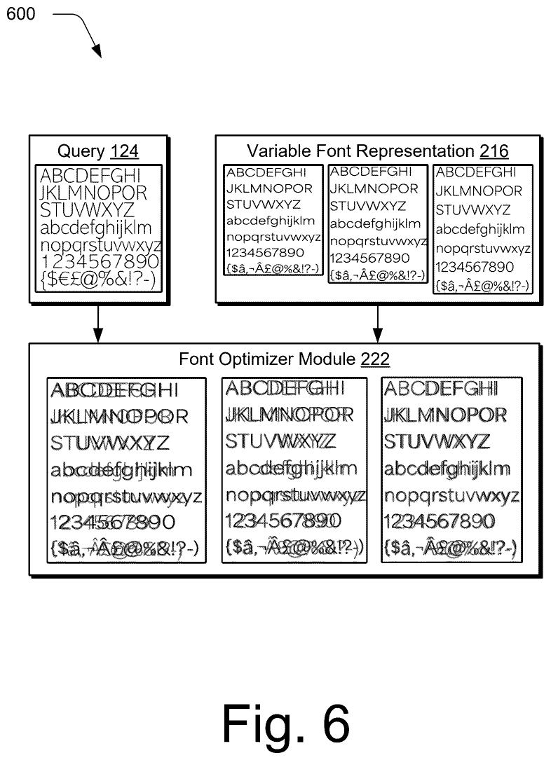

FIG. 6 depicts an example implementation showing convergence of iterations of variable font representations towards an input font of query by the font optimizer module.

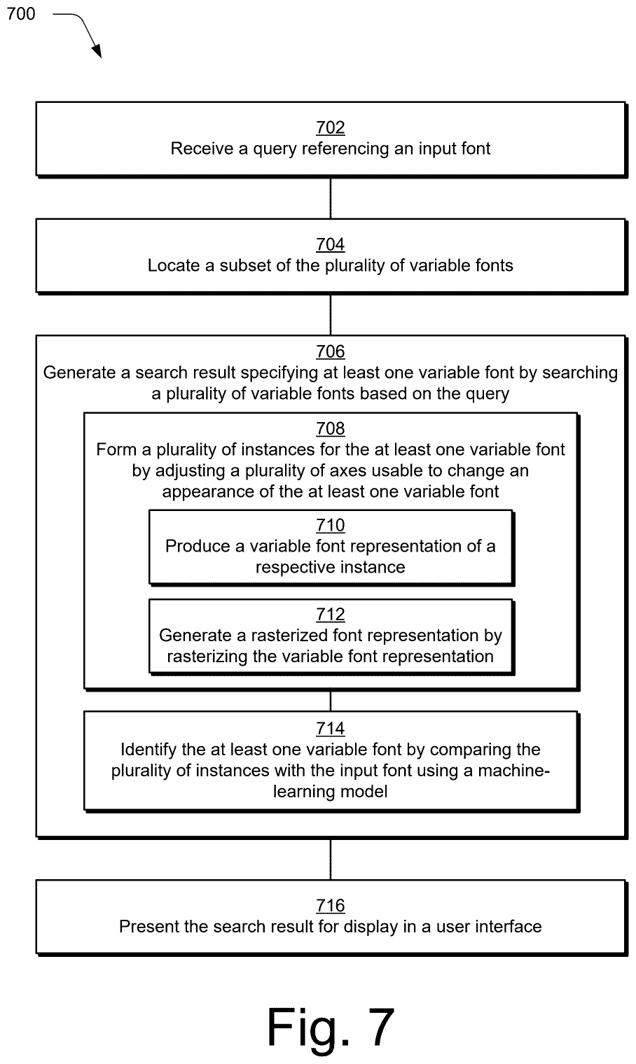

FIG. 7 is a flow diagram depicting an algorithm as a step-by-step procedure in an example implementation of operations performable for accomplishing a result of a variable font visual similarity search.

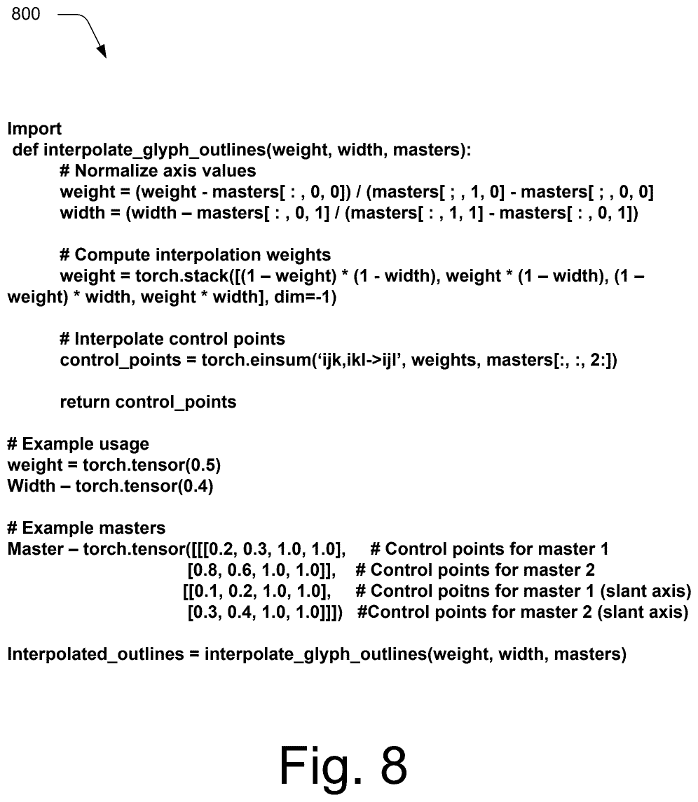

FIG. 8 depicts an example implementation of code specifying instructions that are executable by a processing device to perform interpolation operations as part of implementing the variable font representation module of FIG. 4.

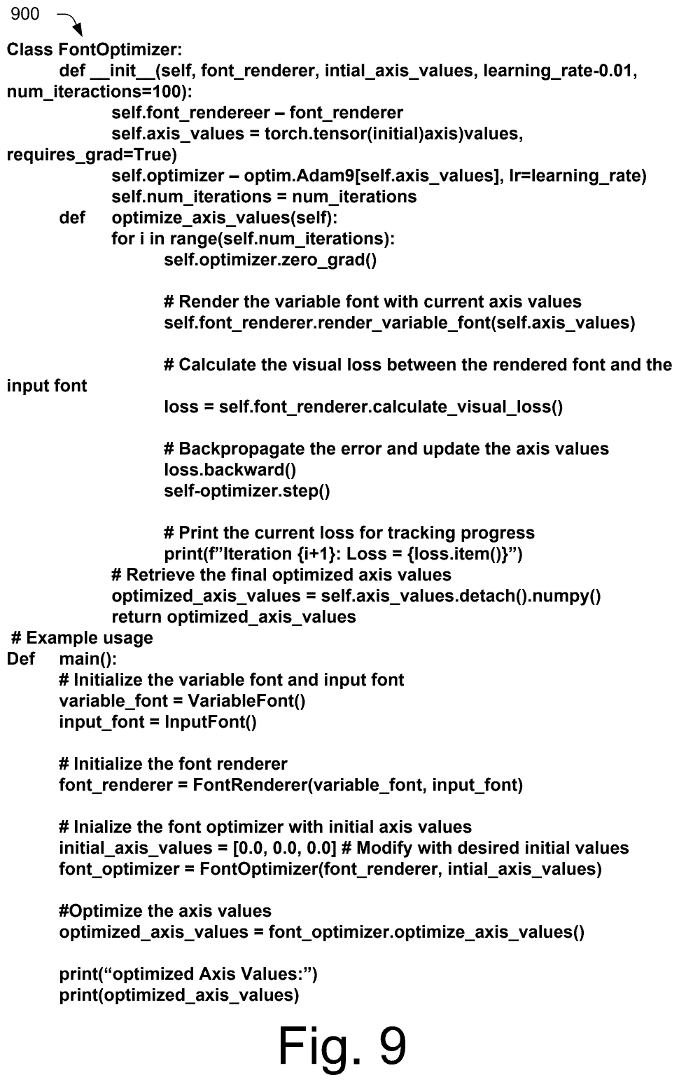

FIG. 9 depicts an example implementation of code specifying instructions that are executable by a processing device to perform optimization operations as part of implementing the font optimizer module of FIG. 5.

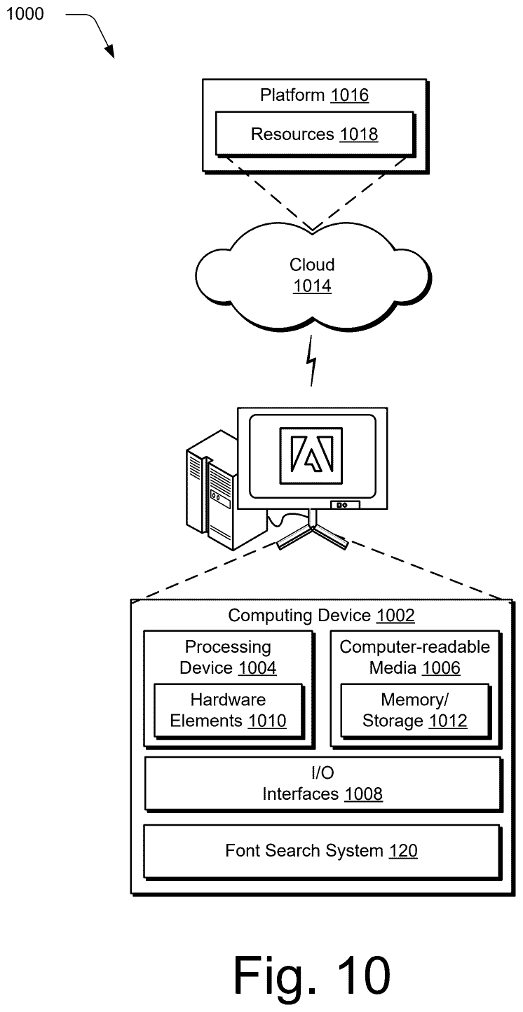

FIG. 10 illustrates an example system including various components of an example device that can be implemented as any type of computing device as described and/or utilize with reference to the previous figures to implement embodiments of the techniques described herein.

### DETAILED DESCRIPTION

### Overview

Variable fonts have been developed to expand the ways in which different instances of a font may be expressed within a single font file. Conventional fonts, for instance, typically rely on different font files to support different visual instances of the font, such as to display italicized, bolded, or italicized and bolded instances of an “arial” font. For a variable font, on the contrary, a single font file supports changes to axes usable to define a visual appearance of the font, e.g., by specifying a weight, width, slant, optical size, and so on. A single variable font file, for instance, may be used to specify both a plain instance as well as a bolded instance of the font by changing a weight axis of the font.

Although variable fonts have expanded expressiveness of the fonts that are made available, variable fonts have introduced additional technical challenges in common workflows undertaken by creatives as part of creating digital content. An example of such a workflow involves a determination of visual font similarity, e.g., as part of search functionality. A digital image, for instance, including a character rendered according to a particular unknown font is usable in this workflow as a search query to locate a visually similar font. However, variable fonts support nearly limitless variations through adjustments to the respective axes and therefore a corresponding nearly limitless embedding space is definable for a single variable font. As a result, conventional search techniques to search in this embedding space for the variable font are difficult if not nearly impossible to perform with reasonable amounts of accuracy.

Accordingly, a font search system and techniques are described that support a variable font visual similarity search, which is not possible in conventional techniques. The font search system, for example, is configured to perform a visual similarity search based on a query, e.g., a query input font, a query digital image depicting a query input font, and so forth. The font search system then locates one or more variable fonts from a variable font library having instances (e.g., as defined by the respective axes) that are visually similar to the query, which is not possible in conventional techniques. Visual similarity refers to a scenario in which an appearance of the input font of the query is similar to an appearance of variable font, e.g., as specified using one or more axis values as further described below. Further these techniques support optimization, improved accuracy, and improved computational resource consumption efficiency for automated operation in real time, which is not possible in conventional techniques.

In one or more examples, a query is received by a font search system that references an input font, e.g., depicts the input font as captured in a digital image, included as part of digital content (e.g., a “copy” from a digital document), and so forth. In an implementation, the font search system employs a neighborhood processing technique to locate a subset of variable fonts maintained in a font library to begin the search and therefore reduce an amount of computational resources used to perform the search. The font search system, for instance, calculates an embedding for each named instance in a variable font and the input font of the query, e.g., using axes values for respective axes of the variable font to define instances of the variable font. The embeddings of the font library may be cached for future use, thereby supporting increased computational resource efficiency.

A distance calculation is then performed within the embedding space to identify variable fonts that are to be included in the subset being searched (e.g., using cosine distance) that are within a threshold of the query, i.e., the input font. Axes values of instances of the variable fonts used in determining the similarity of a respective variable font are stored that represent configuration settings of the variable font's design variations. Storage of the axes values acts as a starting point for generating instances of the variable fonts included in the subset that are then usable to perform the search, which is usable to improve convergence and therefore operation of a machine-learning model used to perform the search as further described below.

The subset is then used by the font search system in this example to perform the search, although other examples are also contemplated in which nearest neighbor functionality is not employed beforehand to limit the search to a subset. To do so, instances of each of the variable fonts are generated by adjusting axes usable to change an appearance of the variable fonts, e.g., beginning with the stored axes values described above. The font search system, for instance, adjusts axes such as weight, width, slant, and so forth that are defined within the variable font file. The variable font file, for instance, includes variation data defining values of axes for different instances along each design axis of the variable font. For example, the variation data defines ranges of values for each axis and how to interpolate those values to produce instances from different axes values, e.g., for a bolded instance of the font, and so forth.

The instances are generated by the font search system in one or more examples mathematically, e.g., as one or more Bezier curves as a scalable vector graphic. Accordingly, a rasterized font representation is then generated by the font search system by rasterizing these instances, an example of which includes use of a differentiable rasterizer.

The font search system then performs a search to generate a search result by comparing the instances formed by the font search system with the input font of the query. To do so, the font search system employs machine learning that takes, as inputs, the query referencing the input font and the rasterized font representation of the variable font. A visual loss is calculated by comparing the query with the rasterized font representation that quantifies a discrepancy between the two inputs, which quantifies a measure of visual similarity between the two inputs.

Values of the axes are adjusted for the rasterized font representation using backpropagation to minimize the visual loss. Axis values are iteratively updated by the font search system based on a gradient of the visual loss until convergence is achieved, achieving an output of resulting values defined for the axes of the variable font that are visually similar. The variable font as having those axes values is then output as the search result.

In this way, the variable font visual similarity search techniques address technical challenges of variable fonts, e.g., as part of a font similarity determination. The font search system, for instance, introduces an auto-regressive differential rasterizer-based training-free machine learning architecture, enabling efficient optimization of instances with gradient pass techniques. To further enhance stability and performance, the font similarity system employs an architecture that leverages improved initialization techniques, incorporating pre-defined instance clustering. Additionally, the font search system is configurable to employ a tensor-based mathematical model for variable fonts, thereby boosting versatility and adaptability for addressing technical problems related to variable fonts. In one or more implementations, the font search system supports significant technical advantages including a training-free nature of machine learning, which allows for seamless integration of subsequent variable fonts without re-training an underlying machine-learning model. As a result, the font search system provides a powerful and scalable solution in the field of font design and optimization. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Variable Font Environment

FIG. 1 is an illustration of a digital medium environment 100 in an example implementation that is operable to employ variable font visual similarity search techniques described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 10.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

The digital services 112 are configurable to support a variety of functionalities involved in digital content creation, management, use, and rendering. An example of these functionalities includes use of a variable font 116, which is illustrated as stored in a storage device 118. The variable font 116 is configurable as a single file having axes that are definable to adjust a visual appearance of the font, i.e., a typeface. Examples of axes include weight, width, slant, optical size, and so forth. The variable font file is also configurable to support predefined values for different axes to achieve particular pre-defined visual characteristics (e.g., “bold”), which are referred to as “masters” later in the discussion.

An example of functionality usable by the digital service manager module 108 as part of the digital services 112 is a font search system 120. Although illustrated as included as one of the digital services 112, the font search system 120 is also implementable locally at the computing device 104 by the communication module 114. The font search system 120 includes one or more machine-learning models 122 to perform a variable font visual similarity search, which is not possible using conventional techniques. The font search system 120, for instance, receives a query 124 and using one or more machine-learning models 122 generates a variable font result 126 as part of a search result. The variable font result 126, for instance, is configured to include values of axes usable to define the variable font 116 as visually similar to the input font of the query 124.

Variable fonts have transformed the world of typography by providing dynamic variations within a multidimensional design space. However, the task of identifying similar instances within this space presents a significant technical challenge. The multidimensional design space of variable fonts encompasses a diverse range of axes as described above, with each axis representing a continuous spectrum of values, thereby resulting in an overwhelming number of potential font instances. With a multitude of variations available, conventional classification techniques fail to support sufficient search accuracy or address the nuances of functionality available from a variable font 116, e.g., changes in values of the axes.

Accordingly, the font search system 120 is configured to locate custom instances of a variable font 116 which are visually similar to a query 124, e.g., a query input font 128 included in digital content, a query digital image 130 depicting the query input font 128, and so forth. The query input font 128, for instance, may be input as a selection of an input font from a digital document, spreadsheet, presentation, and so forth. The query digital image 130 is a digital image having pixels that depict the input font, e.g., as a corresponding glyph, character, number, symbol, and so forth.

In the illustrated user interface 132, for instance, an example 134 of a query input font 128 is depicted as included the text “Handgloves” in a convention font of “Adabi MT Pro Extra Light.” An example 136 of a variable font result 126 is illustrated also for the text “Handgloves.” The example 136 identifies a variable font 116 and includes values of axes generated for the variable font 116 (e.g., “Area Variable Custom Instance” and “slant: 0,” “width: 100,” and “weight: 221”) that cause the variable font 116 to have a visually similar appearance to the example 134 of the query input font 128. In this way, the font search system 120 is configured to address the technical challenges of a variable font 116 as part of a similarity search. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Variable Font Visual Similarity Search Example

The following discussion describes variable font visual similarity search techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 7 is a flow diagram depicting an algorithm 700 as a step-by-step procedure in an example implementation of operations performable for accomplishing a result of a variable font visual similarity search. In portions of the following discussion, reference will be made to FIG. 7 in parallel with the following figures.

FIG. 2 depicts a system 200 showing operation of the font search system 120 of FIG. 1 in greater detail. Font similarity as implemented by the font search system 120 is configurable in support of a variety of functionalities, examples of which include font recommendation, font pairing, and font personalization. With the increasing popularity of variable fonts 116, however, these functionalities are confronted with technical challenges introduced by the variable nature of variable fonts 116. Accordingly, in this example the font search system 120 is configured to implement an auto-regressive differential rasterizer-based training-free machine learning architecture. The illustrated system 200 depicts a high level architecture diagram operation and components of the font search system 120 as implementing variable font modelling and an optimization loop based on differentiable rasterizer.

To begin in the illustrated example, a query 124 is received referencing an input font (block 702). A query processor module 202, for instance, is configurable to receive the query 124 via a user interface responsive to user selection, as an input generated via execution of another digital service 112 or application, and so forth.

The font search system 120 is configured to address a variety of use cases as part of addressing a multitude to customizable instances of each variable font 116 and thus a visual appearance of the variable font 116. The query 124, for instance, is configurable to specify an input font using a query input font 128, a query digital image 130 including a rendering (e.g., a bitmap) of a digital image depicting the input font, and so forth.

The query processor module 202 is also configurable to generate an input as selecting a variable font 116 from a font library 204 maintained by a storage device 206 that is to serve as a basis of a similarity comparison in support of a font visual similarity search. Thus, the query processor module 202 provides a first input of the query 124, which can be provided directly as a digital image or rendered using glyphs of letters A-Z, numbers 0-9, and special symbols as shown in FIG. 3. The second input is a variable font 116, from which, the font search system 120 is to find a similar instance to the input font of the query 124.

In order to increase operational efficiency and reduce computational resource consumption in one or more instances, a subset of the plurality of variable fonts is located (block 704) by a neighborhood processing module 208 as a variable font subset 210. The neighborhood processing module 208 is configured to filter the font library 204 and identify potential variable font candidates before performance of the visual similarity search.

FIG. 3 depicts a system 300 showing operation of the neighborhood processing module 208 of FIG. 2 in greater detail. As illustrated, the query 124 can be received directly as a query digital image 130 or rendered as a query input font 128 using glyphs of letters A-Z, numbers 0-9, and special symbols. An embedding calculation module 302 is then employed to generate a font embedding 304 of the input font from the query 124, e.g., using machine learning as implemented by a machine-learning model.

The embedding calculation module 302, for instance, is configured to map an input font of the query 124 into a high-dimensional vector space (e.g., as a Deep Font embedding), thereby capturing the unique characteristics and features of each font instance. The embedding is a numerical representation that facilitates comparison and similarity analysis.

In an implementation, the font embedding 304 is cached to a storage device 306. Accordingly, the embedding 304 is available for respective variable font 116 from the font library 204 for subsequent use. By maintaining the font embedding 304 in the cache, the font embedding 304 is available without recalculation, thereby preserving computational resources of computing devices that implement the neighborhood processing module 208.

A similarity calculation module 308 is then employed to measure a similarity of the font embedding 304 for each of the variable fonts 116 in the font library 204 to the input font of the query 124 using a distance metric. An example of a distance metric includes a cosine distance, definable as:

cosine_distance (a, b)=1-(a·b)/(∥a∥·∥b∥)

By calculating the cosine distance between the input font's embedding and each cached embedding, a numerical value is obtained that quantifies an amount of similarity.

A threshold filtering module 310 is then employed to form the variable font subset 210 by filtering the numerical values that quantify the amount of similarity of the font embeddings 304 based on a threshold. The threshold filtering module 310, for instance, forms the variable font subset 210 that includes variable font 116 from the font library 204 having embeddings that are within the threshold distance and removing those that do not.

In an implementation, the neighborhood processing module 208 also includes a value storage module 312 that stores axis values 314 in a storage device 316 of instances of respective variable font 116 that meet the threshold criteria. These axis values represent the configuration settings of the variable font's design variations, e.g., for predefined variations to create a bold instance, italicized instance, and so on. The axis values 314 are then employable as a starting point for generating similar instances to improve convergence of a machine-learning model as part of performing a search as further described below. As a result, the neighborhood processing module 208 is configurable to perform embedding calculations, caches the embeddings, calculate similarity distances, filter based on a threshold, and store axis values. This comprehensive approach enables efficient searching and identification of similar instances in variable fonts.

Returning again to FIG. 2, a search result is generated specifying at least one variable font by searching a plurality of variable fonts based on the query 124 (block 706), e.g., by searching the variable font subset 210. To do so, a plurality of instances for the at least one variable font 116 are formed by a variable font representation module 214 as variable font representations 216 by adjusting at least one axes usable to change an appearance of the at least one variable font (block 708).

A variable font representation is produced of a respective instance (block 710). A rasterization module 218 is employed to generate a rasterized font representation 220 by rasterizing the variable font representation 216 (block 712). A font optimizer module 222 is then leveraged to identify at least one variable font by comparing the plurality of instances with the input font using a machine-learning model 224 (block 714). The search result is then presented for display in a user interface (block 716) as further described below.

FIG. 4 depicts a system 400 in an example implementation showing operation of the variable font representation module 214 of FIG. 2 in greater detail. The variable font representation module 214 is representative of functionality for defining and processing the input of variable fonts 116 to the machine-learning model 224 of the font optimizer module 222. In order to do so, the variable font representation module 214 employs a process of generating scalable vector graphic (SVG) representations for each glyph of the variable font subset 210. These SVG representations are then rendered using the differentiable rasterizer module by generating a glyph for each each change in axis value.

As previously described, the variable font 116 is configurable using a single font file to generate multiple variations of a typeface, such as weight, width, and slant, and so forth. These variations are defined as axes within the font file. The variation data in a variable font is also configurable to specify information for generating intermediate instances along each of the axes and ranges of values for each axis. The variation data is also configurable to specify how the font is to be interpolated between predefined master value to produce instances with different attribute values, e.g., to produce a bolded instance, italicized instance, and so forth.

Interpolation rules are variable depending on design decisions made by a respective font designer. A common interpolation technique includes linear interpolation, also known as “lerp” or “scalar interpolation.” Linear interpolation is configured to calculate intermediate values by determining a weighted average between two masters based on a desired position along the axis.

Consider an example with a single axis (e.g., a weight axis) which ranges from a light weight (e.g., “300”) to a bold weight, e.g., “700.” The variable font file defines two “masters” in this example, one for the light weight “300” and another for the bold weight “700.” To generate an instance with a weight value of “500,” the variable font representation module 214 calculates the weighted average between the light and bold masters via interpolation. A variety of interpolation techniques are usable to do so, examples of which include a linear equation or involve complex mathematical functions.

The interpolation rules are also definable to simultaneously address multiple axes. A variable font 116, for instance, may include axes for both weight and width. In such instances, the interpolation is employed by the variable font representation module 214 to calculate a weighted average for each axis independently and then combine the results to generate the final instance as the variable font representation 216.

Consider another example of a variable font with two axes, e.g., weight and width. The variable font representation module 214 is tasked with generating an instance with a weight of “500” and a width of “150.” The variable font representation module 214 begins by obtaining a variable font 116 from the variable font subset 210. An axis determination module 402 is then utilized to determine axis values 404 of preconfigured values for specific instances defined in a variable font file of the variable font 116, i.e., the “masters.”

For linear interpolation technique, a glyph outline for a specific instance of a variable glyph is generated as follows. The masters as configured as predefined values in the variable font file are specified in this example as follows:
Master 1 (weight: “300,” width: “100”); and
Master 2 (weight: “700,” width: “200”).

The variable font representation module 214 utilizes a normalization module 406 to generate normalized axis values 408 by normalizing the axis values 404 (e.g., to a range between “0” and “1”) from the variable font 116 based on minimum and maximum values of each axis. Normalization is used to ensure consistent interpolation calculations across different fonts and axes:
Normalized weight value (w)=(desired weight−min weight)/(max weight−min weight); and
Normalized width value (wi)=(desired width−min width)/(max width−min width).

An outline interpolation module 410 is then employed to generate a glyph outline 412 as the variable font representation 216 mathematically, e.g., using one or more Bezier curves as part of a scalable vector graphic 414. In order to interpolate the glyph outlines, the outline interpolation module 410 interpolates control points of the glyph shapes. Consider a quadratic Bézier curve with control points “P0,” “P1,” and “P2.” The “X” coordinates of the control points are interpolated as follows:
Interpolated P0.x=(1−w)*(1−wi)*P0.x1+w*(1−wi)*P0.x2+(1−w)*wi*P0.x3+w*wi*P0.x4;
Interpolated P1.x=(1−w)*(1−wi)*P1.x1+w*(1−wi)*P1.x2+(1−w)*wi*P1.x3+w*wi*P1.x4; and
Interpolated P2.x=(1−w)*(1−wi)*P2.x1+w*(1−wi)*P2.x2+(1−w)*wi*P2.x3+w*wi*P2.x4.

The “Y” coordinates of the control points are interpolated as follows:
Interpolated P0.y=(1−w)*(1−wi)*P0.y1+w*(1−wi)*P0.y2+(1−w)*wi*P0.y3+w*wi*P0.y4;
Interpolated P1.y=(1−w)*(1−wi)*P1.y1+w*(1−wi)*P1.y2+(1−w)*wi*P1.y3+w*wi*P1.y4; and
Interpolated P2.y=(1−w)*(1−wi)*P2.y1+w*(1−wi)*P2.y2+(1−w)*wi*P2.y3+w*wi*P2.y4.

These equations are configured to calculate the interpolated “X” and “Y” coordinates of the control points based on desired weight and width values. The interpolation process is repeated for each glyph in the variable font 116 to generate complete glyph outlines for a desired instance. FIG. 8 depicts an example implementation of code 800 specifying instructions that are executable by a processing device to perform interpolation operations as part of implementing the variable font representation module 214 of FIG. 4.

FIG. 5 depicts a system 500 showing operation of a rasterization module 218, and font optimizer module 222 of FIG. 2 in greater detail. The variable font representation module 214 includes a font renderer module 502 that is configured to generate the rasterized font representation 220. In this example, however, the rasterization module 218 is also configured to employ differentiable rasterization as represented by a differentiable rasterization module 504 to implement end-to-end differentiation through the rasterization process, enabling gradient-based optimization in computer graphics to generate instances of the variable font 116.

Differentiable rasterization refers to a technique in which rendering is incorporated into a machine-learning model, e.g., a differentiable neural network. In a rasterization pipeline implemented by the differentiable rasterization module 504, interpolation of attributes is performed (e.g., color or texture coordinates) across the pixels within a primitive, e.g., a triangle. This interpolation is formulated in one or more examples using barycentric coordinates as follows:

Attribute=λ0*Attribute0+λ1*Attribute1+λ2*Attribute2,

where “λ0,” “λ1,” and “λ2” represent barycentric coordinates of each pixel within the primitive, and “Attribute0,” “Attribute1,” and “Attribute2” correspond to the attribute values at the vertices. By differentiating this interpolation equation, gradients are obtained and backpropagated through the rasterization process, allowing for the optimization of rendered images using gradient-based methods. Accordingly, in this example a differentiable rasterizer of the differentiable rasterization module 504 is used to optimize an axis of a variable font 116 to find visually similar instance to the input font of the variable font result 126.

The rasterization module 218 is employed to convert vectors of the variable font representation 216 into a rasterized font representation 220 that is usable for optimization by the font optimizer module 222. The rasterization module 218, for instance, converts vector-based shapes of the variable font representation 216 into pixel-based representations of the rasterized font representation 220. Differentiable rasterization as performed by the differentiable rasterization module 504 is utilized to ensure that the rasterization process is differentiable, meaning that small changes in vectors of the variable font representation 216 produce relatively small and continuous changes in a rasterized image of the rasterized font representation 220. This property enables efficient backpropagation of errors during optimization by the font optimizer module 222.

The font optimizer module 222 then employs a machine-learning model 224 which takes as an input the query 124 (e.g., the query input font 128 or query digital image 130) and the rasterized font representation 220 from the rasterization module 218. The font optimizer module 222 is then configured to optimize values of axes of the variable font 116 using a loss function.

The machine-learning model 224, for instance, includes a feature encoder 506 to generate query latent encoded features 508 from the query 124 and candidate latent encoded features 510 from the rasterized font representation 220. A loss function 512 is then employed to calculate a visual loss that quantifies a discrepancy between the encodings. This loss serves as a measure of how well the rasterized font representation 220 visually matches the input font of the query 124.

Using backpropagation, the font optimizer module 222 adjusts the values of

the axis of the custom instance of the font to minimize the visual loss. This optimization process is performed to find optimal values for the axes (e.g., weight, width, etc.) that yield the closest resemblance to the input font. The font optimizer module 222 iteratively updates the values based on the gradient of the visual loss until convergence is achieved, resulting in final values for the instance of the variable font 116 as the variable font result 126. Once the optimization process is complete, the font optimizer module 222 outputs the optimized axis values, which define the instance of the variable font 116 that closely matches, visually, the input font of the query 124.

In an implementation, the loss function 512 uses an L2 loss on a deep font embedding of the fonts, also known as mean squared error (MSE). Mathematically, the L2 loss is definable as follows:

L2_loss=(1/n)*Σ(y_true-y_pred)\hat{ }2

where:
“L2_loss” represents the mean squared error or L2 loss;
“n” is a number of instances in the dataset;
“y_true” represents a true values of the variable; and
“y_pred” represents a predicted values of the variable.
   The L2 loss is computed by the loss function 512 by calculating a squared difference between each true value and its corresponding predicted value, summing up each the squared differences, and then dividing by the total number of samples. The result is a single scalar value that quantifies an overall discrepancy between predictions and true values.

Minimizing the L2 loss during the training process is similar to fitting the predictions to appoximate true values in terms of a Euclidean distance. This loss function is differentiable, making it compatible with gradient-based optimization algorithms that update the input parameters to minimize the loss and improve the accuracy of the predictions. FIG. 9 depicts an example implementation of code 900 specifying instructions that are executable by a processing device to perform optimization operations as part of implementing the font optimizer module 222 of FIG. 5. FIG. 6 depicts an example implementation 600 showing convergence of iterations of variable font representations towards an input font of query by the font optimizer module 222. In this way, the font search system 120 is configured to address the technical challenges of variable font 116 as part of a similarity search.

### Example System and Device

FIG. 10 illustrates an example system generally at 1000 that includes an example computing device 1002 that is representative of one or more computing systems and/or devices that implement the various techniques described herein. This is illustrated through inclusion of the font search system 120. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The computer-readable storage medium is configured for storing instructions that, responsive to execution by the processing device, causes the processing device to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a query referencing an input font for performing a visual similarity search;
generating, by the processing device, a search result specifying at least one variable font that is visually similar to the input font by searching a plurality of variable fonts based on the query, the generating including:
forming a plurality of instances for the at least one variable font, respectively, by adjusting one or more axes usable to change an appearance of the at least one variable font; and
identifying the at least one variable font by comparing the plurality of instances with the input font using a machine-learning model; and
presenting, by the processing device, the search result for display in a user interface.

2. The method as described in claim 1, wherein the search result includes values of at least one said axes of the at least one variable font.

3. The method as described in claim 1, wherein the at least one variable font is configured using a single font file configured to define the plurality of instances.

4. The method as described in claim 1, wherein the one or more axes includes weight, width, slant, and optical size.

5. The method as described in claim 1, wherein the forming includes:
producing a variable font representation of a respective said instance; and
generating a rasterized font representation by rasterizing the variable font representation.

6. The method as described in claim 5, wherein the variable font representation is configured as a vector graphic.

7. The method as described in claim 5, wherein the generating of the rasterized font representation is performed using differentiable rasterization.

8. The method as described in claim 1, wherein the identifying includes comparing latent encoded features generated by the machine-learning model based on the query with latent encoded features generated by the machine-learning model from the plurality of instances of the at least one variable font.

9. The method as described in claim 1, further comprising locating a subset of the plurality of variable fonts that includes the at least one variable font and wherein the generating of the search result is based on the subset.

10. The method as described in claim 9, wherein the locating is performed using a plurality of font embeddings that are maintained in a cache and generated using machine learning from the plurality of variable fonts, respectively.

11. A computing device comprising:
a processing device; and
a computer-readable storage medium storing instructions that, responsive to execution by the processing device, causes the processing device to perform operations including generating a search result specifying at least one variable font by searching, as part of a visual similarity search, a plurality of variable fonts based on a query referencing an input font, the generating including:
forming a plurality of instances for the at least one variable font from a single font file, respectively, by adjusting one or more axes usable to change an appearance of the at least one variable font; and
identifying the at least one variable font as visually similar to the input font by comparing the plurality of instances with the input font using a machine-learning model.

12. The computing device as described in claim 11, wherein the query includes a digital image depicting the input font.

13. The computing device as described in claim 11, wherein the forming includes:
producing a variable font representation of a respective said instance; and
generating a rasterized font representation by rasterizing the variable font representation.

14. The computing device as described in claim 13, wherein the variable font representation is configured as a vector graphic and the generating of the rasterized font representation is performed using differentiable rasterization.

15. The computing device as described in claim 11, wherein the identifying includes comparing latent encoded features generated by the machine-learning model based on the query with latent encoded features generated by the machine-learning model from the plurality of instances of the at least one variable font.

16. One or more computer-readable storage media storing instructions that, responsive to execution by a processing device, causes the processing device to perform operations including:
receiving a query referencing an input font; and
presenting a search result for display in a user interface, the search result specifying at least one variable font and a corresponding axis value located by searching a plurality of variable fonts based on the query referencing the input font.

17. The one or more computer-readable storage media as described in claim 16, wherein the search result is generated by:
forming a plurality of instances for the at least one variable font, respectively, by adjusting a plurality of axes usable to change an appearance of the at least one variable font; and
identifying the at least one variable font by comparing latent encoded features the plurality of instances with latent coded features of the input font using a machine-learning model.

18. The one or more computer-readable storage media as described in claim 17, wherein the forming includes:
producing a variable font representation of a respective said instance as a vector graphic; and
generating a rasterized font representation by rasterizing the variable font representation.

19. The one or more computer-readable storage media as described in claim 18, wherein the variable font representation is configured as a vector graphic and the generating of the rasterized font representation is performed using differentiable rasterization.

20. The one or more computer-readable storage media as described in claim 16, wherein the query includes a digital image depicting the input font and the plurality of axes includes weight, width, slant, and optical size.
